(19) United States
(12) Patent Application Publication
(10) Pub. No.: US 2009/0303132 A1
(43) Pub. Date: Dec. 10, 2009

(54) PLANAR ANTENNAS AND BANDWIDTH EXTENSION APERTURES

(75) Inventor: James P. Smith, Mesa, AZ (US)

Correspondence Address: GARRETT IP, LLC, C/O CPA Global, P.O. BOX 52050, MINNEAPOLIS, MN, 55402, US

(73) Assignee: Intel Corporation, Santa Clara, CA (US)

(21) Appl. No.: 12/133,749

(22) Filed: Jun. 5, 2008

(51) Int. Cl. H01Q 1/38

(52) U.S. Cl. 343/700 MS

(57) ABSTRACT

Methods and systems to implement planar antennas and bandwidth extension apertures, including planar antennas etched in metal clad printed circuit board materials, relatively small-scale planar antennas having dimensions in a range of centimeters and/or millimeters, planar antennas to operate in GHz frequency ranges, and bandwidth extension apertures to alter an antenna impedance, reduce an antenna return loss, reduce an antenna Q factor, and/or increase an antenna frequency bandwidth.

### BACKGROUND

1. Technical Field

Methods and systems disclosed herein are directed to planar antennas and bandwidth extension apertures.

2. Background

In radio technology, bandwidth refers to frequency range, typically measured in Hertz (Hz). A devices may be characterized by a bandwidth within which the device meets one or more criteria. In some applications, such as ultra wideband (UWB) applications, broader antenna bandwidth operation is desired.

UWB systems typically transmit relatively low energy levels over a relatively broad frequency range or spectrum. UWB systems may be used for relatively short-range high-bandwidth communications without interfering with more traditional narrow bandwidth continuous carrier wave systems that operate within a bandwidth of a UWB system.

Conventional UWB antennas include relatively large printed monopole antennas, stand alone monopole antennas that are mechanically complex, and relatively expensive ceramic chip monopole antennas.

### BRIEF DESCRIPTION OF THE DRAWINGS/FIGURES

FIG. 1 is a perspective view of an exemplary antenna system 100.

FIG. 2 is a plot 200 illustrating a simulated scattering parameter magnitude, or S-parameter of antenna system 100.

FIG. 3 is a perspective view of an exemplary antenna system 300, including an exemplary bandwidth extension aperture 302.

FIG. 4 is a plot 400 illustrating an S-parameter magnitude of antenna system 300.

FIG. 5 is a process flowchart illustrating an exemplary method of identifying an area of a planar antenna for a bandwidth extension aperture.

In the drawings, the leftmost digit(s) of a reference number identifies the drawing in which the reference number first appears.

### DETAILED DESCRIPTION

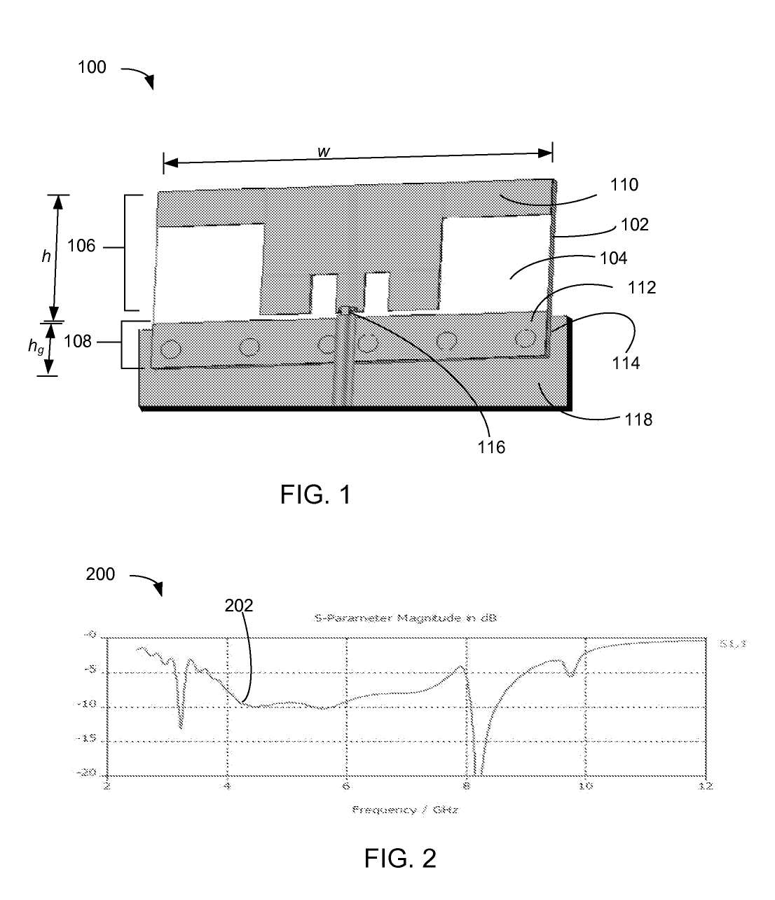

FIG. 1 is a perspective view of an exemplary antenna system 100, including a substrate 102 having a surface 104.

Substrate 102 may be a substantially planar dielectric substrate, such as a printed circuit board substrate, which may be a fire retardant dielectric material commonly known to as Flame Retardant 4, or FR4, available from a variety of manufactures. FR4 materials may be defined as materials that satisfy an Underwriters Laboratories standard UL94-V0, and variations thereof. Substrate 102 may have a thickness of approximately 1 millimeter. Substrate 102 may be a substantially rigid dielectric substrate or a relatively flexible dielectric substrate to conform to a space.

A metal layer is disposed over one or portions of surface 104. The metal layer may include copper. For illustrative purposes, substrate 102 is illustrated as including a radiate portion 106 and a ground plane portion 108. Radiate portion 106 includes a metal layer 110 to radiate within a bandwidth. Ground plane portion 108 includes a metal layer 112. Alternatively, or additionally, ground plane portion 108 may include a metal layer disposed over an opposing surface 114 of substrate 102.

Portions of surface 104 that do not include a metal layer disposed thereon are referred to herein as non-metallized portions.

Metal layer 110 and/or metal layer 112 may be implemented in one or more of a variety of patterns and dimensions to provide one or more characteristics, such as a center frequency, a frequency bandwidth, and/or a radiation beam pattern. For example, and without limitation, antenna system 100 may be configured to radiate within a bandwidth centered about a center frequency, which may be approximately 7 GHz.

Patterns may be etched from an initial metal layer disposed over all or substantially all of surface 104, to expose non-metallized portions of surface 104, and to retain metal layers 110 and 112. Patterns may be etched according to one or more of a variety of conventional printed circuit board etching techniques.

Antenna system 100 may be implemented with a relatively small physical profile, and may be implemented as part of a mobile wireless communication device. For example, and without limitation, a width w of radiate portion 106 may be approximately equal to or less than 2 centimeters. A height h of radiate portion 106 may be approximately equal to or less than 1 centimeter, and may be approximately equal to or less than 8 millimeters.

Antenna system 100 may be coupled to another device 118 at or near ground plane portion 108. Radiate portion 106 may extend beyond device 118 by height h. Device 118 may be a ground plane of a portable communications device, such as a ground plane of a display. a height h_{g} of ground plane portion 108 may be approximately equal to or less than 1 centimeter.

Metal layer 110 may be electrically coupled to a receiver, transmitter, or transceiver through a coupling system 116, which may include one or more of a variety of conventional electrical-to-planar antenna coupling systems, scaled to dimensions of antenna system 100. Coupling system 116 may include a connector, such as a coaxial connector.

FIG. 2 is a plot 200 illustrating a computer simulated scattering parameter magnitude, or S-parameter 202 of antenna 100 system, wherein antenna system 100 is configured to radiate within a bandwidth centered approximately at 7 GHz.

S-parameters are indicative of impedance mismatch between antenna system and a coupling system, and indicative of a corresponding return loss and quality, or Q factor of an antenna system. Higher S-parameter values and impedance mismatches lead to higher return loses and higher Q factors, which correspond to narrower bandwidths. Lower S-parameter values and impedance mismatches correspond to greater energy passed to antenna system 100. S-parameters, impedances, return losses, and Q factors are well known to those skilled in the art.

In matrix notation, as is common in S-parameter evaluation, plot 200 corresponds to an S1,1 input of antenna system 100, at coupling system 116. Plot 200 illustrates an approximately 90% efficiency, or −10 dB return loss, for a 1.7 GHz bandwidth between 4.2 GHz and 5.9 GHz, and for a relatively narrow bandwidth between 8.1 GHz and 8.5 GHz.

Dielectric properties of a dielectric substrate-based antenna system affect the impedance of the antenna system. Accordingly, a planar, dielectric substrate-based antenna may include one or more apertures through the substrate to improve impedance matching, reduce return loss, and/or reduce Q factor, and thus increase bandwidth. The one or more apertures may be sized to substantially preclude the aperture from radiating within a frequency bandwidth of the antenna.

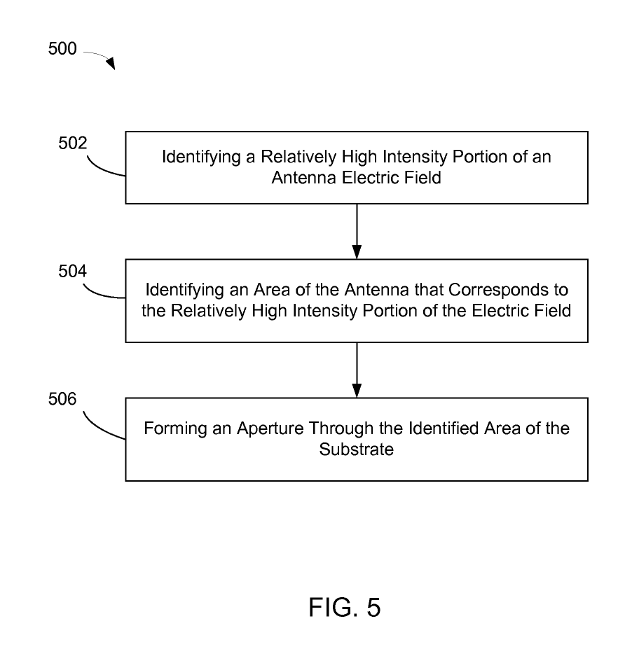

Aperture position, shape, and/or dimensions may be selected and/or determined based on knowledge, experience, experimentation, simulation, and/or measurement of one or more features and/or responses to stimulation. For example, an electric field generated by a dielectric substrate-based antenna is affected by dielectric properties of the substrate. To optimize effects of an aperture, the aperture position may be selected to correspond to an area of relatively high electric field intensity. An exemplary method of identifying an area for a bandwidth extension aperture is disclosed below with respect to FIG. 5.

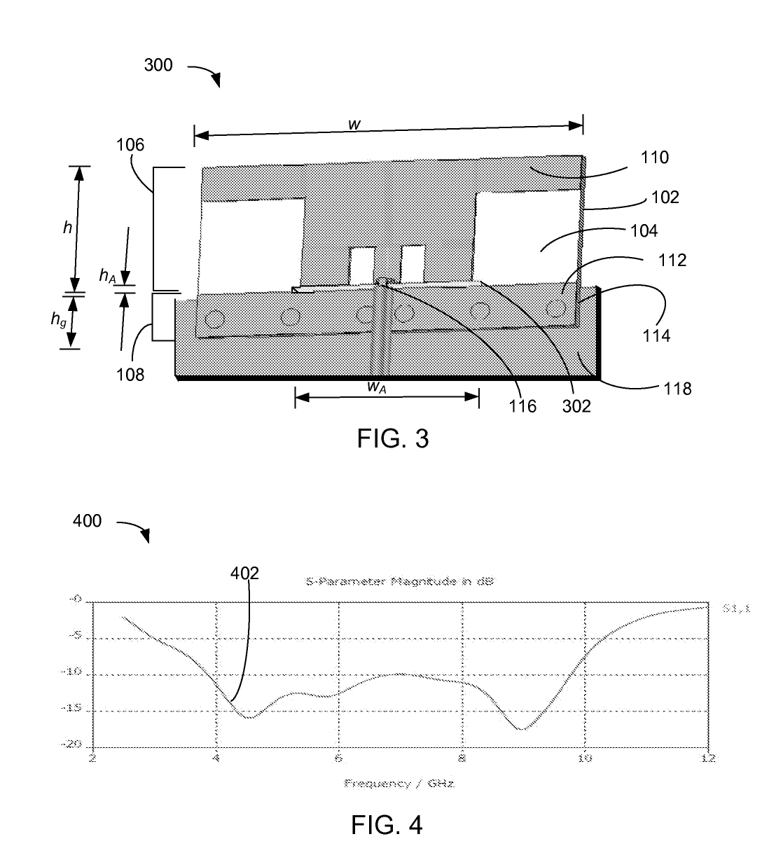

In a monopole antenna system, such as antenna system 100 in FIG. 1, electric fields tend to be relatively more intense between radiate portion 106 and ground plane portion 108. Accordingly, FIG. 3 is a perspective view of an exemplary antenna system 300, including features described above with respect to antenna system 100, and including an exemplary bandwidth extension aperture 302 through surface 104, between radiate portion 106 and ground plane portion 108. Aperture 302 is configured to reduce an impedance mismatch between antenna system 300 and coupling system 116. Aperture 302 may be configured to substantially preclude aperture 302 from radiating within a bandwidth of antenna system 300. Antenna system 300 may be dimensioned as described above with respect to antenna system 100.

In the example of FIG. 3, aperture 302 has an elongated, substantially rectangular shape, referred to herein as a slot. A width w_{A} of aperture 302 is less than width w of radiate portion 106. Aperture width WA may be less than approximately 2 centimeters, and may be approximately 1 centimeter. A height h_{A} of aperture 302 may be less than approximately 2 millimeters, and may be approximately 1 millimeter, and may be less than 1 millimeter.

FIG. 4 is a plot 400 illustrating a computer simulated S-parameter magnitude 402 for antenna system 300, wherein antenna system 300 is configured to radiate within a bandwidth centered approximately at 7 GHz. Plot 400 corresponds to an S1,1 input of antenna system 300, at coupling system 116.

Plot 400 illustrates an approximately 90% efficiency, or −10 dB return loss, for a 5.9 GHz bandwidth between 3.9 GHz and 9.8 GHz. Aperture 302 thus increases the 1.7 GHz bandwidth of antenna system 100 to 5.9 GHz.

Mathematical analyses of antenna system 300, configured to radiate within a bandwidth centered approximately at 7 GHz, indicate that aperture 302 does not substantially radiate below a frequency in a range of approximately 13 GHz to 15 GHz. Computer simulation indicates that aperture 302 does not substantially radiate below approximately 20 GHz. Aperture 302 may thus improve bandwidth without substantially altering a radiation pattern of a planar antenna system.

FIG. 5 is a process flowchart illustrating an exemplary method 500 of identifying an area of a planar antenna for a bandwidth extension aperture.

At 502, a relatively high intensity portion of an antenna electric field is identified. The relatively high intensity portion of the electric field may be identified based on knowledge, experience, experimentation, simulation, and/or measurement of one or more features and/or responses to stimulation.

At 504, an area of the planar antenna corresponding to the relatively high intensity portion of the electric field is identified. The area may be identified from a non-metallized portion of a substrate of the antenna to avoid altering radiation parameters of the antenna. Alternatively, the area may include a metallized portion of the substrate, in which case the metallized substrate may be reconfigured to retain or achieve desired radiation parameters.

At 506, an aperture is cut, drilled, or otherwise formed through the identified area. As noted above, aperture position, shape, and/or other dimensions may be selected and/or determined based on knowledge, experience, experimentation, simulation, and/or measurement of one or more features and/or responses to stimulation.

While various embodiments are disclosed herein, it should be understood that they have been presented by way of example, and not limitation. It will be apparent to persons skilled in the relevant art that various changes in form and detail may be made therein without departing from the spirit and scope of the disclosure. Thus, the breadth and scope of the claims should not be limited by any of the exemplary embodiments disclosed herein.

What is claimed is:

1. An antenna system, comprising:
a substantially planar dielectric substrate; and
a layer of metal disposed over a portion of a surface of the dielectric substrate;
the substrate having an aperture through the surface to alter an impedance of the layer of metal and the substrate.

2. The system of claim 1, wherein the layer of metal is configured to radiate within a frequency bandwidth and the aperture is configured to substantially not radiate within the frequency bandwidth.

3. The system of claim 2, wherein the layer of metal is configured to radiate in a frequency bandwidth having a center frequency greater than 1 GHz.

4. The system of claim 1, wherein the layer of metal and the substrate are configured to have a return loss of not more than approximately −10 dB over a frequency bandwidth greater than 1.7 GHz.

5. The system of claim 1, wherein the layer of metal and the substrate are configured to have a return loss of not more than approximately −10 dB over a frequency bandwidth of at least approximately 5 GHz.

6. The system of claim 1, wherein the aperture has an elongated substantially rectangular shape.

7. The system of claim 6, wherein the layer of metal comprises a monopole radiating element and wherein the aperture is positioned between a radiate portion of the substrate and a ground plane portion of the substrate.

8. The system of claim 1, wherein the substrate comprises a printed circuit board material and wherein the layer of metal includes copper.

9. The system of claim 1, wherein the substrate includes a radiate portion having a width of up to approximately 2 centimeters and a height of up to approximately 1 centimeter, and wherein the aperture has a width of less than 2 centimeters and a height of up to approximately 2 millimeters.

10. The system of claim 9, wherein:
the radiate portion width is approximately 2 centimeters;
the radiate portion height is approximately 7 millimeters;
the aperture width is approximately 1 centimeter; and
the aperture height is approximately 1 millimeter.

11. The system of claim 9, wherein the substrate includes a ground plane portion having a width of up to approximately 2 centimeters and a height of up to approximately 1 centimeter, and wherein the aperture is positioned between the radiate portion and the ground plane portion.

12. The system of claim 1, wherein the substantially planar dielectric substrate comprises a substantially rigid dielectric substrate.

13. The system of claim 1, wherein the substantially planar dielectric substrate comprises a flexible dielectric substrate.

14. A method, comprising:
identifying a relatively high intensity portion of an electric field of a substantially planar, dielectric substrate-based antenna;
identifying an area of the antenna that corresponds to the relatively high intensity portion of the electric field; and
forming an aperture through the antenna proximate to the area.

15. The method of claim 14, further comprising, sizing the aperture to substantially preclude the aperture from radiating within a frequency bandwidth of the antenna.

16. The method of claim 14, further comprising:
etching the antenna in a copper clad dielectric substrate, including etching a radiate portion of the substrate in a width of up to approximately 2 centimeters and a height of up to approximately 1 centimeter;
wherein the forming the aperture includes forming the aperture with a width of less than 2 centimeters and a height of up to approximately 2 millimeters, and positioning the aperture between the radiate portion and a ground plane portion of the substrate.

17. The method of claim 16, wherein:
the etching includes etching the radiate portion of the substrate in a width of approximately 2 centimeters and a height of approximately 7 millimeters; and
the forming the aperture includes forming the aperture with a width of approximately 1 centimeter and a height of approximately 1 millimeter.
